(19) United States
(12) Patent Application Publication
(10) Pub. No.: US 2011/0316676 A1
(43) Pub. Date: Dec. 29, 2011

(54) APPARATUS AND METHOD FOR MANAGING POWER-CONSTRAINED WIRELESS DEVICES

(75) Inventors: Zeljko BAJIC, San Jose, CA (US); Nikola Cargonja, San Carlos, CA (US)

(73) Assignee: Savi Technology, Mountain View, CA (US)

(21) Appl. No.: 13/166,130

(22) Filed: Jun. 22, 2011

Related U.S. Application Data
(60) Provisional application No. 61/357,749, filed on Jun. 23, 2010.

(51) Int. Cl. G06K 7/01

(52) U.S. Cl. 340/10.33

(57) ABSTRACT

A method of interrogating a set of tags with an interrogator is provided. The method includes defining a duration of a wake-up superframe that matches that of a wake-up cycle of the tags; defining an integer number of time periods within the duration of the wake-up superframe such that each time that one of the set of tags wakes is within one of the time periods of the wake-up superframe, the tags waking within a particular time period defining a group of tags; providing a first wake-up signal in a first time period to wake a first group of the tags; and providing a second wake-up signal in a second time period wake a second group of the tags.

### RELATED APPLICATIONS

The present disclosure claims priority to U.S. Provisional Patent Ser. No. 61/357,749, filed on Jun. 23, 2010, which is herein incorporated by reference in its entirety.

### BACKGROUND

1. Technical Field

Embodiments of the present invention relate to communications in low-power wireless applications and, in particular, to wake-up procedures for low-power wireless applications.

2. Description of the Related Arts

Low-power wireless devices such as, for example, radio frequency (RF) tags have been in use for some time. Radio-frequency identification (RFID) systems typically include interrogators that communicate with tags. Tags are typically attached to an article such as a shipping container or a package that is being shipped. The interrogator, then, can inventory the articles that are within its range.

Generally, an RFID tag system will include a number of tags that are attached to an asset such as a piece of inventory or a shipping asset. RFID tags include a transceiver to transmit and receive signals as well as a processor to process incoming signals from an interrogator and provide responses to the interrogator. As such, an interrogator can poll the tags that are within its range. The interrogator, then, can monitor tags as they arrive or leave an area of interest. The interrogator periodically polls the tags within its range. Alternatively, tags can be monitored as they transit a particular area, for example by a signpost or other interrogator device. The bandwidth of the interrogator and its range limits the number of tags that can be monitored by any given interrogator.

Tags have limited power sources. Active tags are typically powered by a battery, which may be depleted with frequent use. To solve this problem, tags can have active and inactive modes of operation (referred to as asleep or awake modes). Therefore, tags need to operate in a power efficient and power saving mode. Some current interrogator and tag systems conform to ISO 18000-7, referred to as Mode 1 tags. However, there is a limit to the capabilities of such a system to conserve power in the tags.

Therefore, what is needed is a communication system that preserves the power in a low-power device while providing for monitoring of a high number of such devices.

### SUMMARY

In accordance with the present invention, an interrogator that communicates with tags can include a processor coupled to a transceiver to transmit wireless signals to the tags, the processor executing a wake-up process by defining a duration of a wake-up superframe that matches that of a wake-up cycle of the tags; defining an integer number of time periods within the duration of the wake-up superframe such that wake-up times of individual tags are distributed within the wake-up superframe falls, the tags being grouped by which one of the time periods during which the tag wakes up; providing a first wake-up signal in a first time period to wake a first group of the tags associated with the first time period; and providing a second wake-up signal in a second time period wake a second group of the tags associated with the second time period.

A method of interrogating a set of tags with an interrogator according to some embodiments of the present invention includes defining a duration of a wake-up superframe that matches that of a wake-up cycle of the tags; defining an integer number of time periods within the duration of the wake-up superframe such that each time that one of the set of tags wakes is within one of the time periods of the wake-up superframe, the tags waking within a particular time period defining a group of tags; providing a first wake-up signal in a first time period to wake a first group of the tags; and providing a second wake-up signal in a second time period wake a second group of the tags.

These and other embodiments are further described below with reference to the following figures.

### BRIEF DESCRIPTION OF THE DRAWINGS

FIG. 1 illustrates RFID systems in which some embodiments of the present invention may be utilized.

FIG. 2 illustrates a dialog between an interrogator and a tag utilized in some RFID systems as shown in FIG. 1.

FIG. 3 illustrates a continuous wake-up signal.

FIG. 4 illustrates a distributed sliding wake-up procedure according to some embodiments of the present invention.

FIG. 5 illustrates a distributed sliding wake-up and collection procedure according to some embodiments of the present invention.

FIG. 6 illustrates a distributed sliding wake-up procedure with another period wake-up interval according to some embodiments of the present invention.

FIG. 7 illustrates a continuous sliding wake-up procedure according to some embodiments of the present invention.

FIG. 8 illustrates a continuous wake-up procedure utilizing multiple beacon intervals according to some embodiments of the present invention.

FIG. 9 illustrates a two-dimensional distribution of the wake-up signal according to some embodiments of the present invention.

FIG. 10 illustrates a collection process using a distributed-sliding wake-up procedure according to some embodiments of the present invention.

FIG. 11 illustrates a collection process using a distributed-sliding wake-up procedure according to some embodiments of the present invention.

FIG. 12 illustrates an adaptive distributed collection procedure according to some embodiments of the present invention.

FIG. 13 illustrates a wake-up signal according to some embodiments of the present invention.

In the figures, elements given the same designation have the same or similar functions.

### DETAILED DESCRIPTION OF EMBODIMENTS

The figures and the following description relate to some embodiments by way of illustration only. It should be noted that from the following discussion, alternative embodiments of the structures and methods disclosed herein will be readily recognized as viable alternatives that may be employed without departing from the principles of the embodiments described herein.

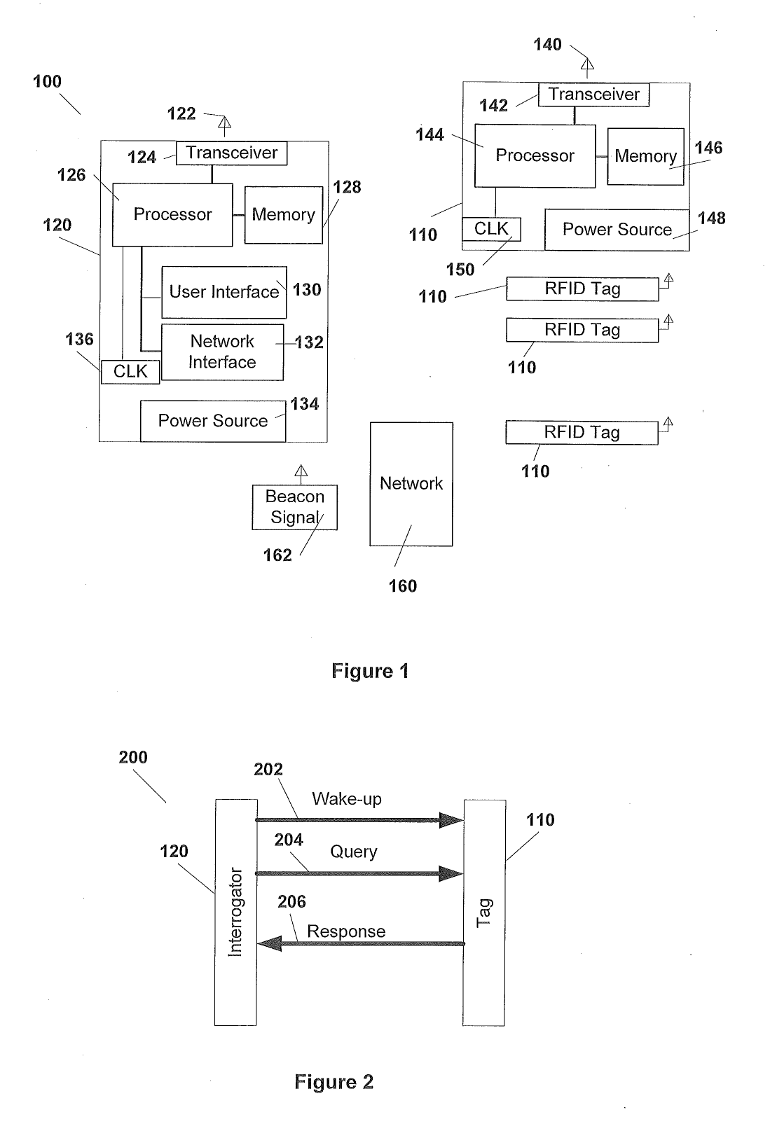

FIG. 1 illustrates a RFID system 100 according to some embodiments of the present invention. FIG. 1 illustrates an interrogator device 120 communicating wirelessly with a number of tags 110. Any number of tags 110 can be located in an area monitored by interrogator 120. Interrogator 120 communicates with one or more of tags 110 wirelessly in order to read or write information from the one or more tags 110.

As is shown in FIG. 1, interrogator 120 includes a processor 126. Processor 126 executes processes, the instructions for which are stored in memory 128, to communicate with tags 110. Memory 128 may also store data and operating parameters, buffers, and registers. Interrogator 120 includes a clock 136 that controls timing for interrogator 120. Processor 126 is coupled to a transceiver 124, which is coupled to an antenna 122, to wirelessly transmit and receive signals with tags 110. Processor 126 may further be coupled to a user interface 130 for communications with a user at interrogator 120 and to a network interface 132 for communications with a network 160 in system 100.

In accordance with some embodiments of the present invention, network 160 may not be present or may represent a single computer system on which data is downloaded from interrogator 120 and stored. Network interface 132 may communicate with network 160 wirelessly, or through a wired connection. If interrogator 120 is a handheld device, data regarding tags 110 may be downloaded to network 160 periodically or as needed.

Interrogator 120 is powered by a power source 134. Power source 134 can, for example, be a battery in a hand-held interrogator. In a fixed interrogator, power source 134 may be coupled to an external power source.

Tag 110 includes a processor 144 coupled to a memory 146. Memory 146 includes instructions and data for processor 144. Processor 144 is further coupled to transceiver 142, which is coupled to antenna 140, through which tag 110 can wirelessly communicate with interrogator 120. Tag 110 includes a clock 150 that provides timing for tag 110. Tags 110 also include a power source 148, which typically is a battery. In tags 110, however, power stored in power source 148 is conserved and conservation efforts are utilized to insure that tags 110 are continuously useful during their use.

In some embodiments, system 100 may include a beacon generator 162 to periodically generate a beacon signal for interrogator 120 and tags 110. In some embodiments, system 100 is synchronized through clock 136. Clock 150 in tags 110 match signals received to the timing of clock 136. In such systems 100, beacon signal generator 162 is absent. In some embodiments, beacon signal generator 162 may be included in interrogator 120. Further, beacon signals generated by beacon signal generator 162 may include information regarding system 100.

System 100 may include any number of tags 110 or interrogators 120. Tags 110, which are often attached to shipments, for example shipping containers, that are in transit between locations are read, or collected, as they come into range of an interrogator 120. System 100 can have any number of interrogators 120, and usually includes a mixture of fixed and handheld interrogators 120.

Although specific examples of aspects of system 100 and of devices 110 are provided below, specific examples are provided only to facilitate better understanding of aspects of the present invention. It is to be understood that other arrangements than those specifically described can be implemented while remaining within the scope of this disclosure.

Typically, tags 110 are low power devices and spend much of their time in a sleep mode of operation. During normal operation, each of tags 110 wakes periodically to monitor for a wake-up signal from interrogator 120. In the 18000-7 protocol, for example, tags 110 wake up once every 2.4 sec to check for a wake-up signal from interrogator 120. Upon wake-up, if tag 110 detects the wake-up signal, tags 110 remain awake to exchange further information with interrogator 120. If no wake-up signal is detected, then tags 110 return to a sleep mode.

FIG. 2 illustrates a dialog 200 between an interrogator 120 and a tag 110. As shown in FIG. 2, interrogator 120 transmits a wake-up signal 202. Tag 110 detects wake-up signal 202 when it wakes and waits for a further signal. Interrogator 120 may, in some cases, follow wake-up signal 202 with a query request 204. In some embodiments, wake-up signal 202 itself operates as a query request. In either case, tag 110 provides a response 206 to interrogator 120. In some embodiments, response 206 is transmitted during a specified time period that results from an arbitration procedure to determine which of a group of tags 110 transmit at which time. Once dialog 200 is complete, then tag 110 returns to a sleep mode, once again waking periodically to determine the presence of another wake-up signal 202.

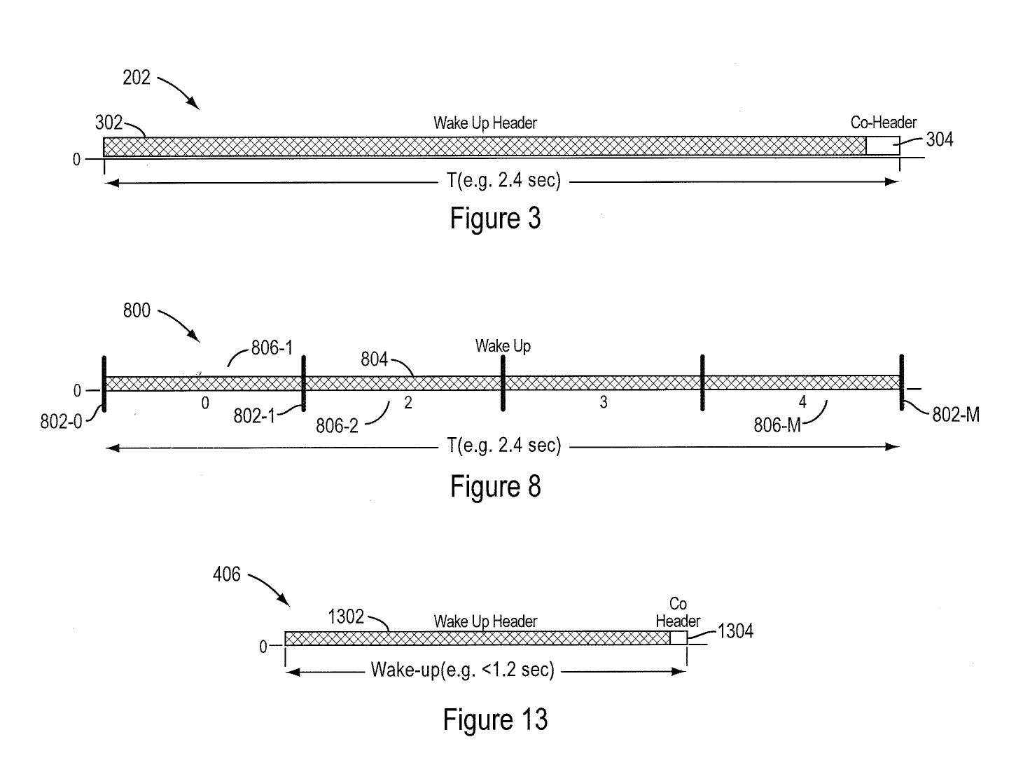

FIG. 3 illustrates a wake-up signal 202 transmitted from an interrogator 120. The example shown in FIG. 3 is of duration T, which can be 2.4 sec in duration in compliance with the ISO 18000-7 protocol. As defined by the ISO 18000-7, wake-up signal 202 is transmitted by interrogator 120 for a minimum of 2.4 seconds to wake up all tags 110 within communication range of interrogator 120. The wake-up signal includes a wake-up header 302, which according to the 18000-7 protocol is 2.3 to 4.8 seconds of a 31.25 kHz square wave modulated signal, and a co-header 304, which according to the 18000-7 protocol is a 0.1 second 10 kHz square wave modulated signal.

Upon detection and by completion of wake-up signal 202, tags 110 enter into a ready state awaiting a command from interrogator 120. As shown in FIG. 2, for example, tag 110 receives query signal 204 after wake-up signal 202. Tag 110 has two states, awake/ready and sleep. During the awake state, tags 110 accept valid commands from interrogator 120 and responds accordingly. When tag 110 is asleep, it ignores all commands until, during a periodic wake period, wake-up signal 202 is received.

Once awake, tag 110 stays awake for a period of time after receipt of the last well-formed message packet from interrogator 120, unless the message packet from interrogator 120 includes a sleep command. A well formed message packet, according to the ISO 18000-7 standard, includes a valid protocol ID, command code, and CRC values. If no well-formed command message is received within the time period, tag 110 transitions to the sleep state and no longer response to command messages until once again detecting a wake-up signal 202.

Communications between interrogator 120 and tag 110 is typically that of the master-slave type, where interrogator 120 initiates communications and then listens for a response from one of tags 110. Multiple response transmissions from multiple tags 110 can be controlled by a collection algorithm that includes arbitration.

However, utilizing a wake-up signal 202 that continuously emits over such a long period of time is not desirable. Wake-up signal 202 occupies, and therefore jams, the airspace for too long a period of time. Wake-up signal 202 itself does not contain any information regarding the source, timestamps, or instructions to tags 110. Further, wake-up signal 202 wakes up all tags 110, which then compete for time on the airspace complicating the collection process and reducing efficiency. The wake-up and collect process should be atomic for the complete population of tags 110, which is difficult under the present environment. Tags 110 should be collected in a more efficient manner while saving power in tags 110.

Therefore, in accordance with embodiments of the present invention, the wake-up signal duration is substantially reduced and arranged such that an integer number of them span the entire wake-up period. The time period T of wake-up signal 202, which hereinafter can be referred to as a wake-up superframe, can be divided into an integer number of wake-up periods. A wake-up signal, that has the same duration as one of the wake-up periods, can occupy individual ones of the wake-up periods in the wake-up superframe. In subsequent wake-up superframe, the wake-up signal occupies different ones of the wake-up periods such that, after a number of wake-up superframes that is greater than or equal to the number of wake-up periods, a wake-up signal has occurred in each of the wake-up periods.

Further, the wake-up times of tags 110 can be arranged to be distributed across the wake-up superframe period T. The wake-up superframe period T can be arranged so that all of tags 110 will wake up to check for a wake-up signal at some time within the wake-up superframe period T. In that case, once a wake-up signal has occurred in each of the wake-up periods in the wake-up superframe, then all of the tags 110 have been woken. Combining with a collection process, then all of the tags 110 will be woken and collected by integrator 120.

The wake-up times of individual tags 110 can be arranged to occur at an arbitrary time during the wake-up superframe. This randomization can occur purposely, by a randomization process, or through the natural drift of a clock within tags 110. In some embodiments, wake-up times can be randomized in tag 110 when a sleep command is received or a normal transition to sleep mode has occurred.

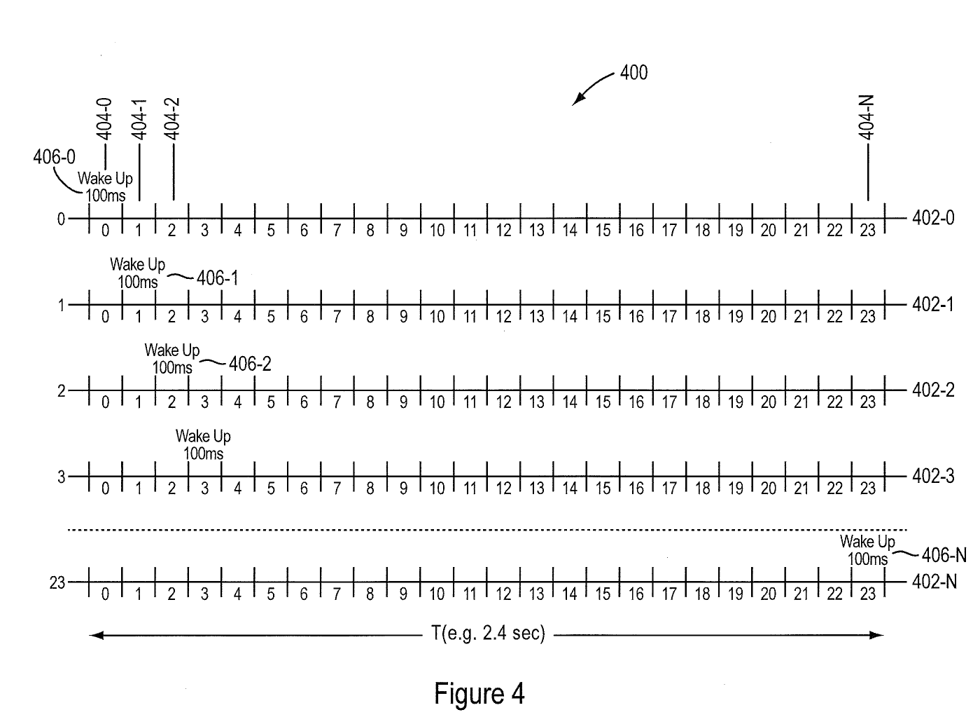

FIG. 4 illustrates a wake-up procedure 400 according to some embodiments of the present invention. As shown in FIG. 4, multiple wake-up superframes 402-0 through 402-N are utilized. Each of the multiple wake-up superframes 402 is separated into time periods 404-0 through 404-N. In each of superframes 402-0 through 402-N, a wake-up signal 406-0 through 406-N, respectively, is sent. In the particular example shown in FIG. 4, N can be 23 so that there are 24 time periods 404 in each of the wake-up superframes 402. If, as is compatible with the ISO 18000-7 standard, the superframe is 2.4 sec. in duration, then each of wake-up signals 406-0 through 40-6-N is 100 ms in duration. Further, it takes 24 superframes to wake-up all of tags 110.

FIG. 4 illustrates a distributed sliding wake-up procedure 400 according to the present invention. As shown in FIG. 4, wake-up signal 406-0 occurs in time period 404-0 of wake-up superframe 402-0. In general, wake-up signal 406-j occurs in time period 404-j of wake-up superframe 402-j, where j is an integer between 0 and N. In implementation, interrogator 120 executing procedure 400 illustrated in FIG. 4 is synchronized with internal clock 136 (FIG. 1). As described above, the timing is derived from the wake-up superframe period, for example 2.4 sec. In the ISO 18000-7 standard, each of tags 110 wakes up every 2.4 seconds and checks for a wake-up signal. If there is no wake-up signal present, tag 110 will go back to sleep for an additional 2.4 seconds. This process repeats until tag 110 receives a wake-up signal 406 and wakes up. On wake-up signal 406 occurs within each of wake-up superframes 402. In that way, the wake-up signals 406 are spread across different time slots 404 in the wake-up superframes 402. Tags 110 will wake to check wake-up signals at different times during the time period of superframes 402. Therefore, each of wake-up signals 406-0 through 406-N will wake a different set of tags 110, but after all of superframes 402-0 through 402-N all of tags 110 have been awaken.

As such then, the wake-up times for tags 110 is distributed across the time of wake-up superframes 402. Tags 110 are then grouped by which of periods 404 the individual tags 110 wake.

In the example specifically illustrated in FIG. 4, after 57.6 seconds (24 2.4 sec superframes 402), all of tags 110 have been awaken by one of wake-up signals 406-0 through 406-N, but not all at the same time. This also means that tags 110 that just arrived within the range of interrogator 120 will be awoken in the time period of N+1 superframes 402 (57.6 seconds in the ISO 18000-7 example).

As shown in FIG. 4, the wake-up signals 406 slide through different time slots of each subsequent wake-up superframe 402. As such, the overhead (e.g. the percentage of time spent sending wake-up signals) for transmitting wake-up signals 406 is 1/(N+1). In the ISO 18000-7 compatible example illustrated in FIG. 4 where wake-up superframe 402 is 2.4 sec and is divided into 24 time slots 404, then the overhead is 1/24 or 4.17%.

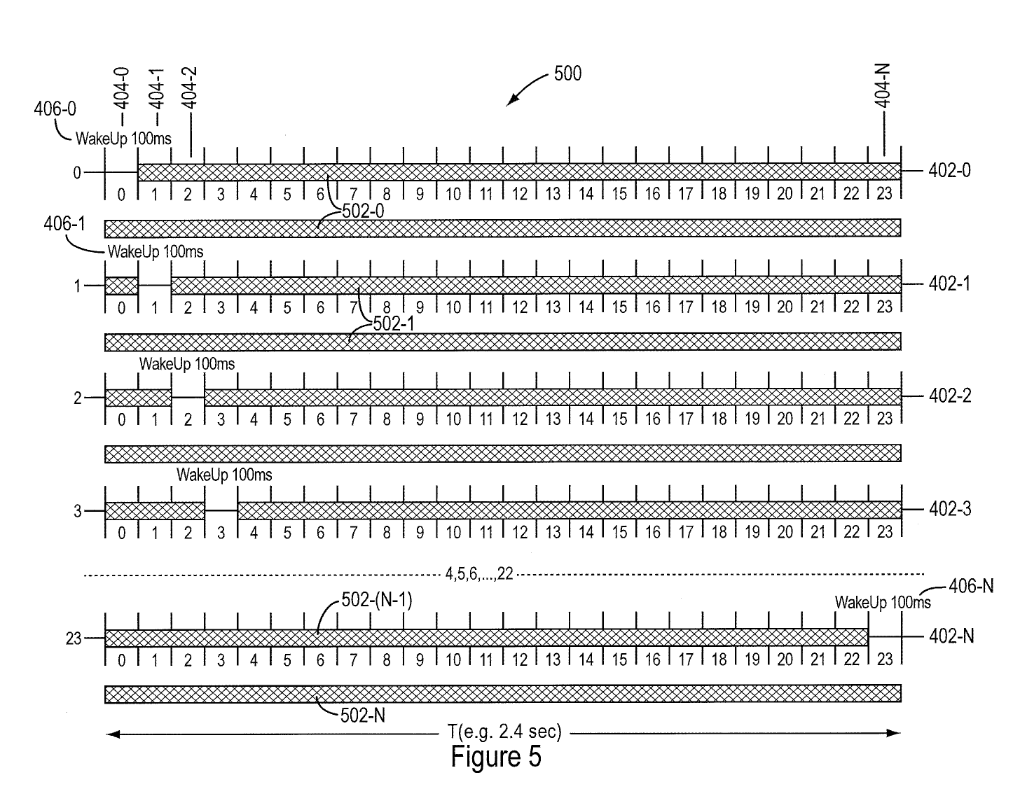

FIG. 5 illustrates a wake-up and collection process 500 utilizing the sliding-distribution wake-up procedure 400 illustrated in FIG. 4. As shown in FIG. 5, after each wake-up signal 406 there is a collections period 502. Collection period 502-0 may include any number of intervals of equivalent duration to that of the wake-up superframe 402. For example, after wake-up signal 406-0, which occurs in period 404-0 of wake-up superframe 402-0, collections period 502-0 is utilized to perform dialogs such as dialog 200 shown in FIG. 2 with each of tags 110 that detected wake-up signal 406-0. Collections period 502-0 utilizes the remaining time periods 404-1 through 404-N of wake-up superframe 402-0 and may utilize an integer number of periods that have the same duration T as wake-up superframe 402-0, as well as period 404-0 of wake-up period 402-1. When collections period 502-0 is completed, then wake-up superframe 402-1 occurs and wake-up signal 406-1 is presented in time period 404-1 of wake-up superframe 402-1.

Consistently with the ISO 18000-7 standard, if wake-up superframe 402 is 2.4 seconds in duration and wake-up signal 406 is 100 msec in duration, then there are 24 time periods 404. Collection period 502, then, is an integer number of 2.4 sec intervals, as shown in FIG. 5. Following each collection period 502, the next group of tags 110 is woken up by the next wake-up signal 406.

Although FIGS. 4 and 5 depict wake-up superframes 402 of duration T (e.g., 2.4 sec), broken up into 24 time periods 404 of duration 100 msec, the duration T can have any value and N can have any integer value. The time duration 404 is then the time T/(N+1). For example, the duration of time intervals 404 can be, for example, 100 msec (N=23), 200 msec (N=11), 400 msec (N=5), 600 msec (N=3), 800 msec (N=2), or 1200 msec (N=1). Duration of wake-up superframes 402, T, is based on the wake-up period of Tags 110. Tags that adhere to the ISO 18000-7 standard wake-up every 2.4 sec, and therefore it is convenient to set T=2.4 sec in that case because each of tags 110 will then wake-up during one of wake-up signals 406-0 through 406-N. The latency for waking up all of tags 110 is, not counting the collections period 502, (N+1)T. With N=23 and T=2.4, that is a latency of 57.6 seconds to wake-up all of tags 110. The overhead, as discussed above, is 1/(N+1) or 4.17%. If N is 3, which for T=2.4 sec. leads to a wake-up signal 404 duration of 600 msec, the latency will be 9.6 seconds and the overhead will be 25%. As another example, if N=2 leading to a wake-up signal 404 duration of 800 msec with T=2.4 sec., the latency will be 7.2 seconds while the overhead is 33%. In general, the higher the overhead, the shorter the latency will be.

As discussed above, the number of periods 404 in a wake-up superframe 402 should be balanced to obtain acceptable latency and overhead. Table I illustrates several examples, based on a wake-up superframe of T=2.4 sec duration. In Table I, the bolded rows indicate values for the number of periods 404 that may be most useful. Large numbers of periods 404 lead to very short wake-up signal 406 durations and very large latencies. Very low numbers of periods 404 lead to long wake-up signals but very high overheads.

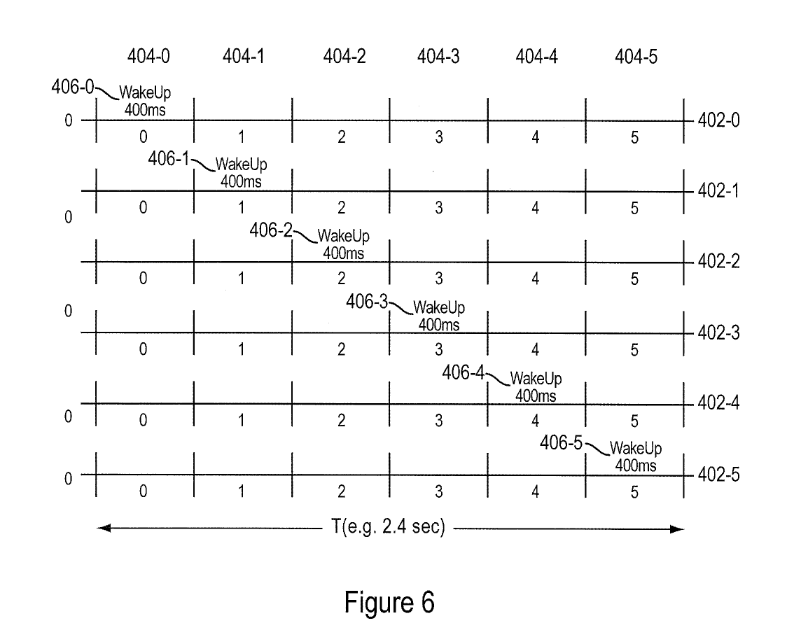

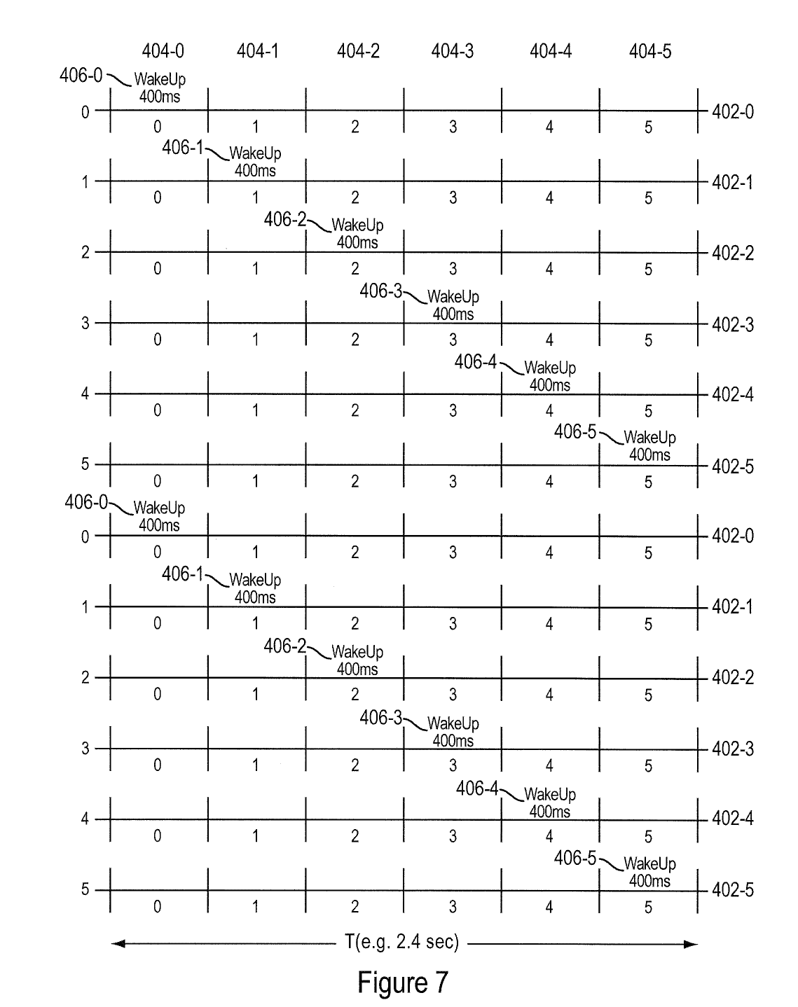

FIGS. 6 and 7 illustrate examples of a distributed sliding wake-up algorithm with N=5 (which, for T=2.4 sec, corresponds to a 400 msec wake-up signal 404 duration). As shown in FIG. 6, wake-up signal 406-0 occurs in time period 404-0 of wake-up superframe 402-0. In the next wake-up superframe 402-1, wake-up signal 406-1 occurs in time period 404-1. Progressively, the wake-up signal occurs in the next time period of the next frame. As shown in FIG. 7, once a wake-up signal 406 occurs in each of time periods 404, one wake-up signal 406 in each of wake-up superframes 402, then the process can start over. FIGS. 6 and 7 illustrate a distributed sliding wake-up algorithm according to some embodiments of the present invention.

TABLE I
Latency and Overhead for various numbers of periods.

| | Wake-up signal | | |
|---|---|---|---|
| Number of periods | 406 duration | Overhead | |
| 404 | (milliseconds) | (1/(N + 1)) (%) | Latency (seconds) |
| 24000 (N = 23999) | 0.100 | 0.00416 | 57,600 |
| | (100 microsec) | | (960 min or |
| | | | 16 hrs) |
| 1536 (N = 1535) | 1.5625 | 0.065 | 3686.4 |
| | | | (61.44 min) |
| 768 (N = 767) | 3.125 | 0.13 | 1843.2 |
| | | | (30.72 min) |
| 384 (N = 383) | 6.25 | 0.26 | 921.6 |
| 192 (N = 191) | 12.5 | 0.5 | 460.8 |
| 96 (N = 95) | 25 | 1 | 230.4 |
| 48 (N = 47) | 50 | 2 | 115.2 |
| 24 (N = 23) | 100 | 4.16 | 57.6 |
| 12 (N = 11) | 200 | 8.33 | 28.8 |
| 8 (N = 7) | 300 | 12.5 | 19.2 |
| 6 (N = 5) | 400 | 16.6 | 14.4 |
| 4 (N = 3) | 600 | 25 | 9.6 |
| 3 (N = 2) | 800 | 33.33 | 7.2 |
| 2 (N = 1) | 1200 | 50 | 4.8 |

In some embodiments, after a collection procedure 502, interrogator 120 may provide a sleep command to tags 110 that have been queried. In some embodiments, the collection procedure is modified so that the sleep command includes a specification of how long tag 110 should sleep because of the number of wake-up superframes 402 it takes to wake all of the tags 110. In other words, in the example of N=23999 above, tags that have detected the wake-up signal and have been queried should sleep for at least 16 hrs before checking for another wake-up signal 406. The wake-up signal 406 for that tag 110 can not occur within a shorter time frame.

In some embodiments, the wake-up process does not happen continuously. In some embodiments, the wake-up process only happens periodically. In other words, the wake-up process occurs every set period of time. In the distributed sliding wake-up process described above with respect to FIGS. 4-6, N+1 wake-up superframes 402 are utilized with a wake-up signal 406 in a sliding one of periods 404 in each of the wake-up superframes 402. In that way, all of tags 110 are queried every set period of time. The set period of time may be of any duration, for example 10, 20, 30, 40, 60 or 120 minutes. Or it may be a set time each day or week. Such a procedure can be suitable for certain types of deployments where tags 110 are pretty static. Sites with fast moving tags 110 may be configured to perform continuous processing because there it is more important to shorten the latency for discovering newly arrived tags 110 and determining tags 110 that have departed.

In some embodiments, RFID system 100 can be a beacon synchronized system, such as Extended Mode ISO 18000-7 based on IEEE802.15.4 MAC. Embodiments discussed above can operate with interrogator 120 and tags 110 each providing their own internal clocks 136 and 150, respectively, where the timing in tag 110 is synchronized with clock 136 of interrogator 120. In a beacon synchronized system, a beacon signal is provided periodically by a beacon signal generator 162, which provides timing for RFID system 100. In some embodiments compatible with the ISO 18000-7 standard, the beacon signal can occur every 400 msec. Therefore, FIGS. 6 and 7 can also depict embodiments of the present invention that operate with a beacon synchronized system. In this example, with T=2.4 sec and N=5, each wake-up signal 406 occupies the duration between adjoining beacon signals. In some embodiments, a beacon signal is implemented as an IEEE802.15.4 beacon control frame in Extended Mode ISO 18000-7.

FIG. 8 illustrates a continuous wake-up 804 over multiple beacon intervals 806 in a beacon synchronized process 800. As shown in FIG. 8, beacon signals 802-0 through 802-M occur such that an integer number of beacon intervals 806-1 through 806-M span continuous wake-up signal 804. In particular, with M=4 and T=2.4 sec., beacon intervals 806 are provided at 600 ms intervals through wake-up signal 804.

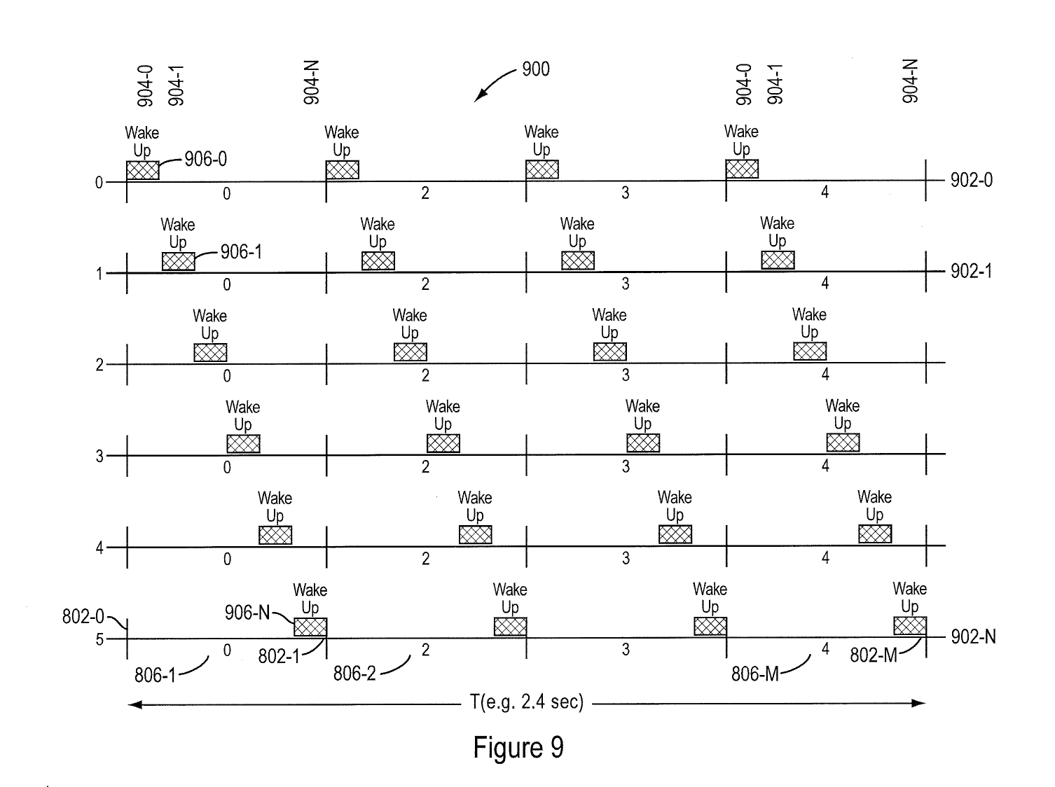

As shown in FIG. 4, beacon intervals 806-1 through 806-M can provide the timing for wake-up signals 406, with N=3. However, in accordance with some embodiments of the present invention beacon intervals 806 can themselves be separated to provide for wake-up signals. This is shown in process 900 of FIG. 9, for example.

In a beacon enabled network, the duration of wake-up signal 904 can be reduced below a beacon interval 806. Further, wake-up signal 904 can be distributed between beacon intervals 806 in a wake-up superframe 902. As shown in FIG. 9, wake-up signals 906-0 through 906-N occur within one beacon interval 806. For example, wake-up signals 906-1 through 906-N can occur between beacon signal 802-0 and 802-1. Wake-up signals 906-1 through 906-N can also occur in each of beacon intervals 806-2 through 806-M. As shown in FIG. 9, wake-up signal 906-0 can occur in time period 904-0 of each of beacon intervals 806-1 through 806-M of wake-up superframe 902-0. Similarly, wake-up signal 906-N can occur in period 904-N of each of beacon intervals 806-1 through 806-M in wake-up superframe 902-N. This provides a two-dimensional distribution of wake-up signals 906.

As a particular example, the duration of wake-up superframe 902 can be T=2.4 sec, the number of beacon intervals in wake-up superframe 902 can be M=4, and each beacon interval can be split into six periods (N=5). In that case, 24 wake-up signals (N*(M+1)) that will span all periods in the T=2.4 sec. wake-up superframe 902 within six wake-up superframes 902-0 through 902-5. Therefore, latency in this example is (N+1)T or 14.4 sec. Overhead in this case is M/(N+1) or 67%.

In general, two-dimensional distribution of wake-up signal 904 as shown in FIG. 9 divides tags 110 into M*(N+1) groups (24 groups in the example above), although each superframe 902 is divided into M beacon intervals 806. In single distribution of wake-up signal 904, as shown in FIG. 5, for example, there would only be M groups of tags 110. Multi-dimensional distribution further address the issue of evenly waking up a population of a large number of tags 110 in a shorter period of time without waking an unmanageable number of tags 110 at any given time.

In some embodiments of the invention, wake-up signal 406 illustrated in FIG. 4 or wake-up signal 906 illustrated in FIG. 9 can send information along with the wake-up frame to wake a set of tags 110. The wake-up signal 406 or 906 can, for example, include the source of the wake-up (e.g., the identification of interrogator 120), the type of interrogator 120 (e.g., fixed, handheld, or other), the vendor of interrogator 120, when the next wake-up is scheduled (in sec., number of beacons, or other parameter), the session identification number, and other information or commands. In some embodiments, wake-up signals 406 or 906 may carry different information, depending on whether interrogator 120 is a fixed or a handheld interrogator. Tag 110 may support two types of collections, one initiated if interrogator 120 is a handheld and another initiated if interrogator 120 is a fixed interrogator. The source of wake-up signal 406 or 906 can be used by tag 110 and may, for example, respond to a handheld interrogator even though it has already been collected by a fixed interrogator.

In an RFID beacon synchronized network such as Extended Mode ISO 18000-7 based on IEEE802.15.4 MAC, a beacon frame (for example, an IEEE802.15.4 control frame) is sent out by an RFID interrogator 120 or other device every beacon interval 806. In some embodiments, the beacon frame properly advertises the sliding wake-up signal 906 information. In some embodiments, this information can be included in a beacon sliding wake-up information element. The beacon sliding wake-up information element can include the type of sliding wake-up signal (none, continuous, periodic, or other type), the periodic sliding wake-up interval, and the sliding wakeup bitmap, which is a field that will advertise the sliding wake-up properties.

The beacon sliding wake-up information element may be transmitted in the separate beacon frame (e.g., an IEEE802.15.4 control frame) 802-0 through 802-M shown in FIG. 9. This information element can be received by already woken/active tags. From this information element, active tags 110 will learn about sliding window properties. For example, active tags 110 should arrange to not transmit, or perform arbitration (e.g., CSMA) during the period for transmission of the sliding wake-up signal specified in the wake-up information element in beacon 802. This would cause unneeded collisions and would be waste the power available to active tag 110. The wake-up period 404 specified in the sliding wake-up information element is like a Guarantied Time Slot (GTS) dedicated for wake-up signal 406. Tags 110 in sleep mode cannot receive the beacon and interpret the sliding wake-up information element. Although tags 110 can save last received wake-up information element before they go to sleep mode. If tags 110 are woken up in the same network by wakeup signal they may try to interpret the last received one before receiving a new one a beacon frame.

Once awoken, tags 110 stay awake for a period of time. In the ISO 18000-7 standard, for example, tags 110 stay awake for a minimum of 30 seconds, the inactivity period T_{S}, after receipt of the last well-formed message packet consisting of a valid Propocol ID, command code, and CRC values, unless interrogator 120 otherwise commands tag 110 to sleep. The moment in time when a tag 110 goes to sleep determines which of the multiple wake-up groups where tag 110 is a member. The collection of evenly populated wake-up groups is more efficient than the collection of unevenly distributed wake-up groups. Therefore, in some embodiments tags 110 may initiate methods to distribute themselves across all of the period 404 or 904.

As discussed above, tags 110 wake-up periodically to check for a wake-up signal 406 or 906. In accordance with some aspects of the present invention, the wake-up times for each of a large number of tags 110 should be randomized across the time frame of a wake-up superframe 402 or 902. As shown in FIG. 4, then, ideally the same number of tags 110 wakes to detect wake-up signal 406-0 as wake-up to detect any other wake-up signal, 406-1 through 406-N.

In some embodiments, tags may be distributed into groups by a self-created method. In this case, no special procedure is executed to distribute an individual tag 110 into one of the groups. Instead, the wake-up timing of individual tags 110 is randomized naturally, for example through natural drift of the clocks in each of tags 110 or through random arrival times of tags 110 that have not been synchronized with a local system.

In some embodiments, tags 110 can be randomized into wake-up groups through randomization of the inactivity interval. As discussed above, tags return to a sleep mode after a time period T_{S}. In other words, tags 110 are set to enter sleep mode after a certain period of time after receipt of the last well-formed message packet consisting of a valid packet. The period T_{S} can be randomized to be T_{S}+xT, where T is the duration of a wake-up superframe 402 or 902 and x is a random number between −1 and 1. Each tag 110 generates a random number x less than 1 and will sleep after T_{S}+xT. Its wake-up period, then, will be every period T, but the start of that wakeup period is randomized within a 1T interval.

In some embodiments, tags 110 can be randomized into wake-up groups through randomization of the sleep-all command. In this case, when a sleep-all command is received from interrogator 120, tag 110 will not immediately transition to sleep mode. Instead, each tag 100 transitions at after a period T_{S} to be xT, where T is the duration of wake-up superframe 402 or 902 and x is a random number between 0 and 1. Optionally, tag 110 may transition to sleep mode immediately, but set its first wake-up time at a time T+xT, where x is a random number between 0 and 1. Subsequent wake-ups will be at time T. As a result, each of tags 110 is randomized to wake-up in one of periods 404-0 through 404-N in FIG. 4, or one of 904-0 through 904-N in one of beacon periods 806-1 through 806-M in FIG. 9. Tags 110 will then be randomly grouped to wake-up at a particular timing in the wake-up process.

In some embodiments, tags 110 may be purposely grouped to wake up within one of the time periods 404-0 through 404-N of FIG. 4, or one of 904-0 through 904-N of one of the beacon periods 806-1 through 806-M in FIG. 9. For example, a table with a tag ID, tag manufacturer ID, or other tag attributes can be extended with a virtual wake-up group element. Tags 110 can be explicitly grouped in the wake-up process with the sleep command a time parameter. This method can be combined with other randomization processes.

In some embodiments, a sleep group command can be utilized. A sleep group command can send all tags 110 within a particular group to sleep at the same time, without randomization. In that fashion, tags 110 retain their groupings over time.

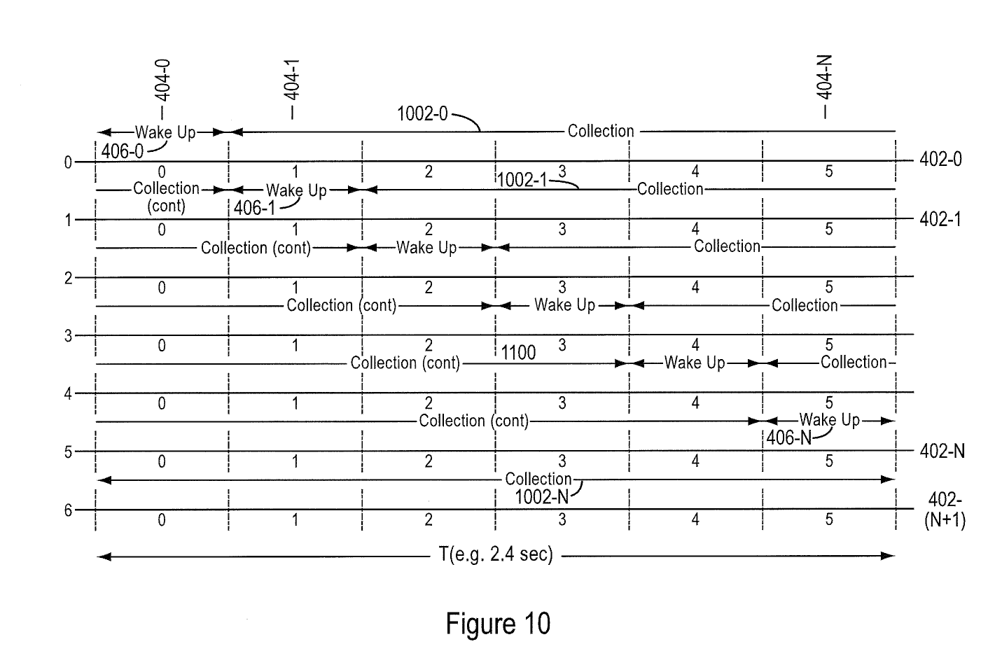

FIG. 10 depicts the distributed wake-up process 1000 according to some embodiments of the present invention. In the example illustrated in FIG. 10, system 100 is not synchronized with a beacon signal as is illustrated in FIGS. 8 and 9. Instead, synchronization is accomplished with an internal clock in interrogator 120. As illustrated in FIG. 10, for example, wake-up superframes 402-0 through 402-N of duration T is utilized for timing. Each of wake-up superframes 402-0 through 402-N are separated into time (N+1) time periods 404-0 through 404-N. As an example, T may be 2.4 sec, which is consistent with the ISO 18000-7 standard, and N may be 5, dividing each of superframes 402 into 6 time periods. As illustrated in FIG. 10, a collection period 1002 may follow each wake-up signals 406. As shown in FIG. 10, wake-up signal 1002-0 follows collection signal 406-0 and collection period 1002-N follows wake-up signal 406-N. As illustrated in process 1000 of FIG. 10, each of the groups of tags 110 is woken and collected within (N+2)T.

In process 1000 shown in FIG. 10, the population of tags 110 is distributed across the T time frame so that each tag 110 wakes up to check for a wake-up signal 406 during one of the periods 404-0 through 404-N. In the example of FIG. 10, all of the tags woken in one period are then collected within the time T.

The population of tags 110 is randomized to wake-up at different times across a wake-up superframe 402 and are grouped into (N+1) groups depending on which time period 404-0 through 404-N each tag 110 wakes to check for a wake-up signal 406. The population in each group does not necessarily contain the same number of tags 110. Therefore, the time needed in collection 1002 will also not be the same. For some groups, the time for collection may be less than T and for other groups the time may be greater than T. Accordingly, in accordance with some embodiments of the invention, a session based sliding distributed collection process can be employed. In some embodiments, an adaptive distributed collection process can be employed.

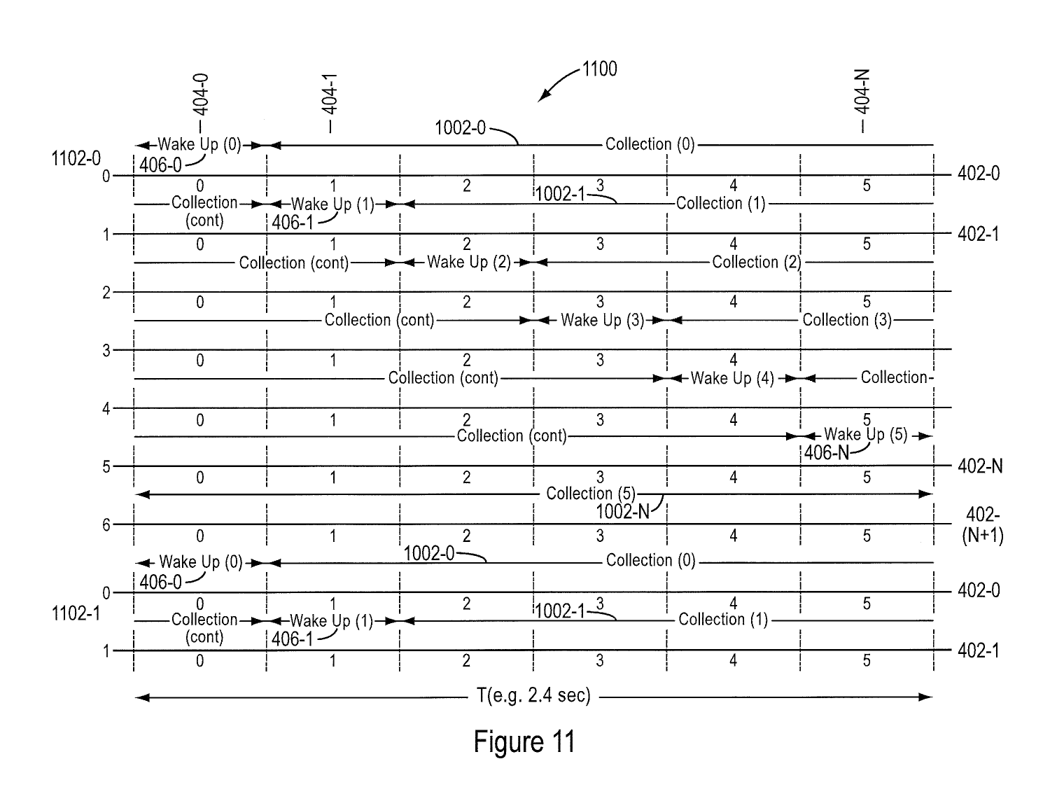

FIG. 11 illustrates a session based distributed collection process 1100. As illustrated in FIG. 11, each collection period 1002-0 through 1002-N is of duration T. Process 1100, therefore, includes multiple iterations 1102-0 through 1102-K in order to collect all of tags 110. Process 1100 includes a session number that is transmitted in each of wake-up signals 406. In process 1100, once a collection period 1002 is over, the process moves to the next wake-up signal 406 even if all of tags 110 that belong to the previous group have not been collected. For example, once collection period 1002-0 has reached the 1T time duration, then wake-up signal 406-1 occurs in period 404-1 of wake-up superframe 402-1. Tags 110 in the group associated with time period 404-0 that where not collected in collection 1002-0 of iteration 1102-0 return to sleep mode and wake up in each period 404-0 to look for a wake-up signal. Once iteration 1102-0 is completed, process 1100 starts over in process 1102-1 with the same session number. Tags 110 that where collected in a previous iteration, for example iteration 1102-0, then return to sleep upon receipt of a wake-up signal 406 with the same session number. In some embodiments, a sleep command may include instructions to ignore the next wake-up signal 406 with the same session number.

As a result, in iteration 1102-1, wake-up signals 406-0 wake tags 110 that belong to the group associated with period 404-0 that where not collected in iteration 1102-0. Any number of iterations can be utilized until all of tags 110 have been collected by interrogator 120. As illustrated in FIG. 11, in iterations 1102-0 collection 1002-0 collects tags 110 that where woken by wake-up signal 406-0, collection 1002-1 collects tags 110 that where woken by wake-up signal 406-1, and collection 1002-N collects tags 110 that where woken by wake-up signal 406-N. In 1102-1 and subsequent iterations, if any, collection 1002-0 through 1002-N collect tags 110 that where woken by wake-up signals 406-0 through 406-N, respectively, that where not collected in a previous iteration 1102 of the same session.

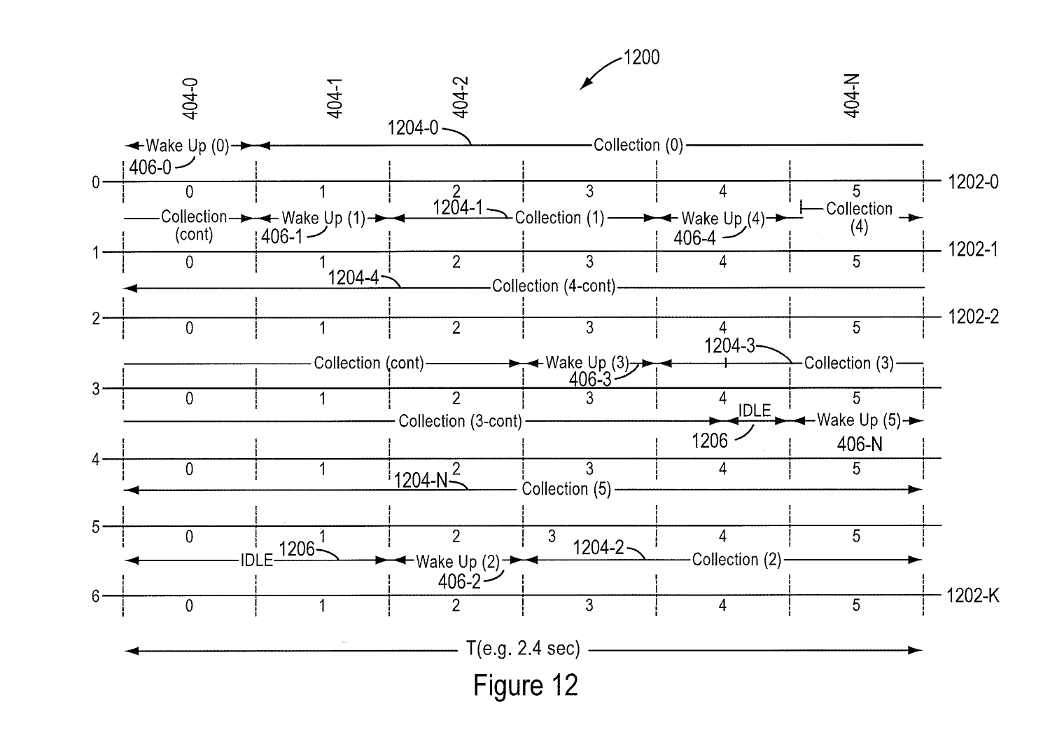

FIG. 12 illustrates an adaptive distributed collection process 1200. Process 1200 address the issue that all devices groups are not populated with the same number of devices and therefore some groups of devices need more than the time T for collection. In process 1200, groups of tags 110 are not woken in a sequence or order, i.e. it is not that case necessarily that tags 110 in the group associated with time period 404-2 are woken directly after tags 110 in the group associated with time period 404-1. Further, more than one group may be woken in a single one of superframes 1202-0 through 1202-K. Instead, interrogator 120 maintains a map of each group that has been woken in the collection process and arranges that all of tags 110 are eventually woken, and not woken more than once, within process 1200. In some embodiments, interrogator 120 may maintain a bit-map to track each group that has been woken up. Procedure 1200 may be efficient, but is also more complex to implement.

As shown in FIG. 12, for example, collection 1204-0 follows wake-up 406-0 in wake-up superframe 1202-0. Collection 1204-0 may take any number of time periods 404. In the example shown in FIG. 12, collection 1204-0 takes just N+1 periods and ends in period 404-0 of wake-up superframe 1202-1. In that case, wake-up signal 406-1 can occur in period 404-1 of wake-up superframe 1202-1. Collection 1204-1 immediately follows wake-up period 406-1. As shown in the particular example of FIG. 12, collection 1204-1 occupies time periods 404-2 and 404-3. In that case, wake-up 406-4 can occur in period 404-4 of wake-up superframe 1202-1. Again, wake-up 404-4 is followed by collection 1204-4. In other words, once a collection 1204 is completed, a wake-up signal 406 is sent to wake-up a group that has not previously been woken. As shown in wake-up superframe 1202-K, if a collection 1204 ends then an idle period 1206 can occur until a wake-up signal 406 can be transmitted to a group corresponding to one of periods 404 that has not already been woken. Once all groups have been woken in process 1200, then process 1200 can be restarted to collect tags 110 again.

As discussed above, interrogator 120 may keep a bit map in order to determine which groups have been collected in process 1200 and which groups need to be collected in process 1200. For example, in the particular example of FIG. 12, with N=5, then once wake-up signal 406-0 has been transmitted the bit map in interrogator 120 can be set to 000001. After wake-up superframe 1202-1, where wakeup signals are sent to the groups corresponding to time periods 404-1 and 404-4, then the bit map is set to 010011. After wake-up superframe 1202-3, where wake-up signal 406-3 is sent to the group corresponding to time period 404-3, then the bit map is set to 011011. This process continues until all of the groups have been awaken. There may be any number of wake-up superframes 1202-K, depending on how long collections 1204 take. Further, idles 1206 are utilized to wait for the first time period 404 whose group has not yet been awaken.

FIG. 13 illustrates a wake-up signal 406 or a wake-up signal 906 according to some embodiments of the present invention. As shown in FIG. 3, an ISO 18000-7 compatible wake-up signal 202 is 2.4 to 4.9 seconds with a wake-up header 302 that is 2.3 to 4.8 seconds of 31.25 kHz square wave with a co-header 304 of 0.1 second duration of 10 kHz square wave. However, wake-up signal 406 is shorter and may be modulated to contain information as discussed above. The same wake-up signal 406 can be utilized for both handheld and fixed interrogators 120, although a handheld interrogator wake-up signal 406 may different from a fixed interrogator wake-up signal 406. In some embodiments, as shown in FIG. 2, query 204 may advertise the capabilities of system 100 and may contain more information about interrogator 120 and system 100, similar to the role of a beacon frame in a beacon synchronized network. In some embodiments, tag 110 may respond differently if interrogator 120 is a handheld interrogator or if interrogator 120 is a fixed interrogator and provide other information as described above.

The embodiment described above are exemplary only and should not be considered to be limiting on the scope of the invention. One skilled in the art will recognize variations on the described embodiments that are also including in the scope of this invention. Therefore, the scope of the invention is limited only by the following claims.

What is claimed is:

1. An interrogator that communicates with tags, comprising:
a processor coupled to a transceiver to transmit wireless signals to the tags, the processor executing a wake-up process by
defining a duration of a wake-up superframe that matches that of a wake-up cycle of the tags;
defining an integer number of time periods within the duration of the wake-up superframe such that wake-up times of individual tags are distributed within the wake-up superframe falls, the tags being grouped by which one of the time periods during which the tag wakes up;
providing a first wake-up signal in a first time period to wake a first group of the tags associated with the first time period; and
providing a second wake-up signal in a second time period wake a second group of the tags associated with the second time period.

2. The interrogator of claim 1, wherein one wake-up signal is provided at a different one of the time periods in each of the wake-up superframes such that all of the tags are woken after completion of all of the wake-up superframes.

3. The interrogator of claim 1, wherein wake-up signals are provided in sequential time periods of sequential wake-up superframes.

4. The interrogator of claim 3, wherein collection periods follow each of the wake-up signals wherein tags that belong to the woken group are collected.

5. The interrogator of claim 4, wherein the collection period has duration equal to the duration of the wake-up superframe.

6. The interrogator of claim 5, wherein an iteration wakes all of tags and wherein multiple iterations are performed so that tags that belong to a group that where not collected in a first iteration can be collected in a subsequent iteration.

7. The interrogator of claim 4, wherein the collection period has duration that is an integer number of the duration of the wake-up superframe, the collection period duration being dependent on a number of tags in a group defined by the time period of the wake-up signal.

8. The interrogator of claim 1, further including a bit map register and wherein wake-up signals are provided periodically in the wake-up superframes into wake-up signals have been provided in each of the time periods, the processor determining in the bit map register which groups of tags have been woken.

9. The interrogator of claim 8, wherein each wake-up signal is followed by collection period, the collection period being determined by the number of tags in the corresponding group, and the next wake-up signal occurring in the first available time period determined by the bit map register following the collection period.

10. The interrogator of claim 1, including a beacon signal generator, the beacon signal generator providing an integer number of beacon periods within the duration of the wake-up superframe.

11. The interrogator of claim 10, wherein the time periods such that they fall within the beacon periods, and wherein wake-up signals occur within each of the beacon periods.

12. The interrogator of claim 10, wherein wake-up signals are provided in sequential time periods within sequential beacon periods in the wake-up superframe.

13. A method of interrogating a set of tags with an interrogator, comprising:
defining a duration of a wake-up superframe that matches that of a wake-up cycle of the tags;
defining an integer number of time periods within the duration of the wake-up superframe such that each time that one of the set of tags wakes is within one of the time periods of the wake-up superframe, the tags waking within a particular time period defining a group of tags;
providing a first wake-up signal in a first time period to wake a first group of the tags; and
providing a second wake-up signal in a second time period wake a second group of the tags.

14. The method of claim 13, including providing one wake-up signal at a different one of the time periods in each of the wake-up superframes such that all of the tags are woken after completion of all of the wake-up superframes.

15. The method of claim 13, including providing wake-up signals in sequential time periods of sequential wake-up superframes.

16. The method of claim 15, including providing collection periods following each of the wake-up signals wherein tags that belong to the group woken in that time period are collected.

17. The method of claim 16, wherein the collection period has duration equal to the duration of the wake-up superframe.

18. The method of claim 17, providing iterations of wake-up sessions, wherein an iteration wakes all of tags and wherein multiple iterations are performed so that tags that belong to a group that where not collected in a first iteration can be collected in a subsequent iteration.

19. The method of claim 16, wherein the collection period has duration that is an integer number of the duration of the wake-up superframe, the collection period duration being dependent on a number of tags in the group defined by the time period of the wake-up signal.

20. The method of claim 13, including providing wake-up signals throughout the wake-up superframes into time periods that have not already been utilized, and tracking the time periods that have not been utilized with a bit map register so that each group of tags is woken only once in an iteration.

21. The interrogator of claim 20, including collecting from the tags following each wake-up signal, wherein duration of the collection period is determined by the number of tags in the corresponding group, and providing the next wake-up signal in the first available time period as determined by the bit map register following the collection period.

22. The interrogator of claim 13, including providing a beacon signal, the beacon signal providing an integer number of beacon periods within the duration of the wake-up superframe.

23. The interrogator of claim 22, wherein the time periods such that they fall within the beacon periods, and wherein wake-up signals occur within each of the beacon periods.

24. The interrogator of claim 23, wherein wake-up signals are provided in sequential time periods within sequential beacon periods in the wake-up superframe.
